(19) United States
(12) Patent Application Publication
(10) Pub. No.: US 2013/0270135 A1
(43) Pub. Date: Oct. 17, 2013

(54) STRIP FOR SUPPORTING FASTENERS

(71) Applicant: Ching Yun HUANG, Changhua (TW)

(72) Inventor: Ching Yun HUANG, Changhua (TW)

(21) Appl. No.: 13/445,996

(22) Filed: Apr. 13, 2012

(51) Int. Cl. F16B 27/00; B65D 85/24

(52) U.S. Cl. 206/347

(57) ABSTRACT

A strip includes a number of barrels coupled together and disposed side by side, the barrels each include a bore and an open upper portion for receiving and engaging with a fastener, and the barrels each include an enclosed lower end portion for receiving the tip of the fastener and for preventing the tip of the fastener from being exposed. The barrels are coupled together with a number of coupling members, and the coupling member each include a hinge line for allowing the barrels to be easily disengaged from each other, when required. The coupling members each include a reinforcing member for solidly coupling the barrels together.

### BACKGROUND OF THE INVENTION

1. Field of the Invention

The present invention relates to a supporting strip device, and more particularly to a fastener supporting strip including a number of sleeves or barrels coupled together for carrying and supporting and organizing and protecting staples, fasteners, nails, screws, bolts, or the like, and for preventing the tips of the staples, fasteners, nails, screws, bolts, or the like from being exposed and from hurting people.

2. Description of the Prior Art

Various kinds of typical fastener supporting strips have been developed and provided for carrying and supporting staples, fasteners, nails, screws, bolts, or the like and comprise a longitudinal belt or strip member for attaching or mounting or securing and supporting the staples, fasteners, nails, screws, bolts, or the like, and for feeding or supplying the staples, fasteners, nails, screws, bolts, or the like toward a nose portion of a driver body member or fastener driver and then for allowing the staples, fasteners, nails, screws, bolts, or the like to be hammered or driven or moved out of the nose portion of the driver body member or fastener driver by the ejector.

For example, U.S. Pat. No. 5,509,768 to Hon, U.S. Pat. No. 5,758,768 to Habermehl et al., U.S. Pat. No. 5,779,420 to Huang, U.S. Pat. No. 5,931,298 to Huang, U.S. Pat. No. 6,074,149 to Habermehl et al., and U.S. Pat. No. 6,494,322 to Habermehl et al. disclose several of the typical fastener supporting strips each also comprising a belt or strip member for attaching or mounting or securing and supporting the staples, fasteners, nails, screws, bolts, or the like.

However, the tips of the staples, fasteners, nails, screws, bolts, or the like normally include a sharp configuration and are extended out of the belt or strip member such that the tips of the staples, fasteners, nails, screws, bolts, or the like are exposed and may have a good chance to hurt people or users.

For the other staples, fasteners, nails, screws, bolts, or the like that are not provided for applying to the driver body member or fastener driver, the other staples, fasteners, nails, screws, bolts, or the like are normally and randomly received in a receptacle and have not been organized, and the tips of the staples, fasteners, nails, screws, bolts, or the like may also be exposed and may have a good chance to hurt people or users.

The present invention has arisen to mitigate and/or obviate the afore-described disadvantages of the conventional fastener supporting strips.

### SUMMARY OF THE INVENTION

The primary objective of the present invention is to provide a fastener supporting strip including a number of sleeves or barrels coupled together for carrying and supporting and organizing and organizing and protecting staples, fasteners, nails, screws, bolts, or the like, and for preventing the tips of the staples, fasteners, nails, screws, bolts, or the like from being exposed and from hurting people.

In accordance with one aspect of the invention, there is provided a strip comprising a number of barrels coupled together and disposed side by side, the barrels each including a bore formed therein and having an open upper portion for receiving and engaging with a fastener and for allowing the staples, fasteners, nails, screws, bolts, or the like to be suitably carried and supported and organized, and the barrels each including an enclosed lower end portion for receiving a tip of the fastener and for preventing the tip of the fastener from being exposed.

A number of coupling members may further be provided for coupling the barrels together, and the coupling member is coupled between every two adjacent barrels. The coupling members each include a hinge line formed therein for allowing the barrels to be easily disengaged from each other when required. The coupling members each include a reinforcing member provided thereon for solidly coupling the barrels together.

The barrels are disposed in a tilted status relative to the coupling members for allowing the heads of the fasteners to be offset from each other. The barrels each include a notch formed in the upper portion thereof and communicative with the bore of the barrel for allowing the fasteners to be easily and quickly and readily engaged into and disengaged from the bore of the barrel.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial front plan schematic view of a fastener supporting strip in accordance with the present invention;

FIG. 2 is a partial perspective view of the fastener supporting strip;

FIG. 3 is a partial cross sectional view of the fastener supporting strip;

FIGS. 4, 5, 6 are partial front plan schematic views illustrating the other arrangements of the fastener supporting strip;

FIGS. 7, 8, 9 are partial perspective views illustrating the further arrangements of the fastener supporting strip;

FIGS. 10, 11 are partial front plan schematic views of the fastener supporting strips as shown in FIGS. 8 and 9 respectively;

FIG. 12 is a partial cross sectional view of the fastener supporting strip as shown in FIGS. 4-11;

FIGS. 13, 14 are partial front plan schematic views similar to FIGS. 1, 10 and 11, illustrating the still further arrangements of the fastener supporting strip;

FIGS. 15 and 16 are front plan schematic views each illustrating one of the barrels of the fastener supporting strip;

FIGS. 17, 18 are cross sectional views illustrating the operation of the still further arrangements of the fastener supporting strip; and

FIGS. 19, 20, 21 are partial cross sectional views illustrating the folding or storing arrangement of the fastener supporting strip.

### DETAILED DESCRIPTION OF THE PREFERRED EMBODIMENT

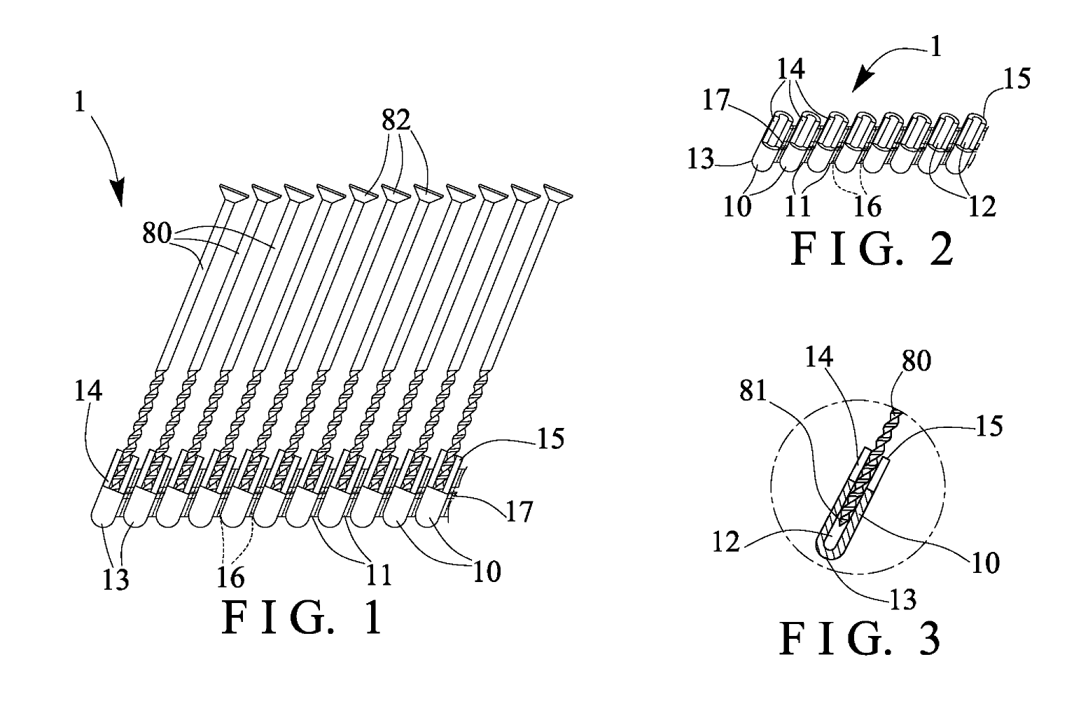

Referring to the drawings, and initially to FIGS. 1-3, a fastener supporting strip 1 in accordance with the present invention comprises a number of sleeves or barrels 10 coupled together with connecting or coupling ribs or members 11; i.e., a coupling member 11 is coupled between every two adjacent barrels 10, the barrels 10 are disposed or arranged side by side and each include a cavity or bore 12 formed therein and having an open upper portion 15 for receiving or engaging with and for carrying and supporting and protecting fasteners 80, staples, nails, screws, bolts, or the like, and the bores 12 of the barrels 10 are blind bores 12 each having an enclosed or blocked end portion 13 for receiving or engaging with the tips 81 of the fasteners 80 (FIG. 3), staples, nails, screws, bolts, or the like, and for preventing the tips of the fasteners 80, staples, nails, screws, bolts, or the like from being exposed and from hurting people.

The barrels 10 each further include a cut-off portion or notch 14 formed in the upper portion 15 thereof and communicative with the bore 12 thereof for allowing the fasteners 80, staples, nails, screws, bolts, or the like to be easily and quickly and readily engaged into and disengaged from the bore 12 of the barrel 10. The barrels 10 may be disposed or arranged in a tilted or inclined status relative to each other or relative to the coupling members 11 which may include a cut or punch or folding or hinge line 16 formed therein for allowing the coupling members 11 to be easily broken or cut and for allowing the barrels 10 and the fasteners 80 to be easily disengaged from each other, when required. It is preferable, but not necessarily that the coupling members 11 each may further include a protrusion or projection or reinforcing member 17 formed or provided thereon for solidly and stably coupling the barrels 10 together and for preventing the hinge lines 16 from being easily broken or cut.

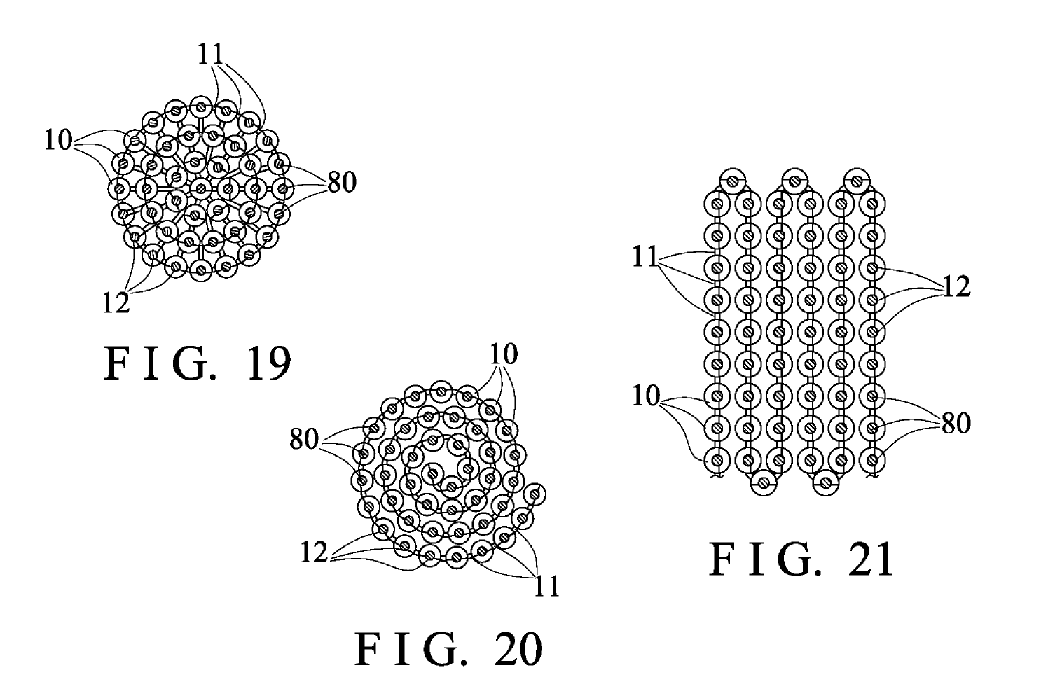

In operation, as shown in FIG. 1, the fasteners 80 that are carried and organized on the barrels 10 may have their end portions or tips shielded and protected by the barrels 10. The provision of the hinge lines 16 in the coupling members 11 allows the barrels 10 and the fasteners 80 to be easily disengaged from each other. The barrels 10 and the fasteners 80 may be folded and stored in circles as shown in FIG. 19, or in a coil as shown in FIG. 20, or in parallel lines as shown in FIG. 21, or the like. The fastener supporting strip 1 may thus be used to carry and hold and support and organize the fasteners 80 (FIG. 3), staples, nails, screws, bolts, or the like, and for preventing the tips of the fasteners 80, staples, nails, screws, bolts, or the like from being exposed and from hurting people, and the barrels 10 and the fasteners 80 may be hit or hammered into the work piece by the user with the hammer or other tools.

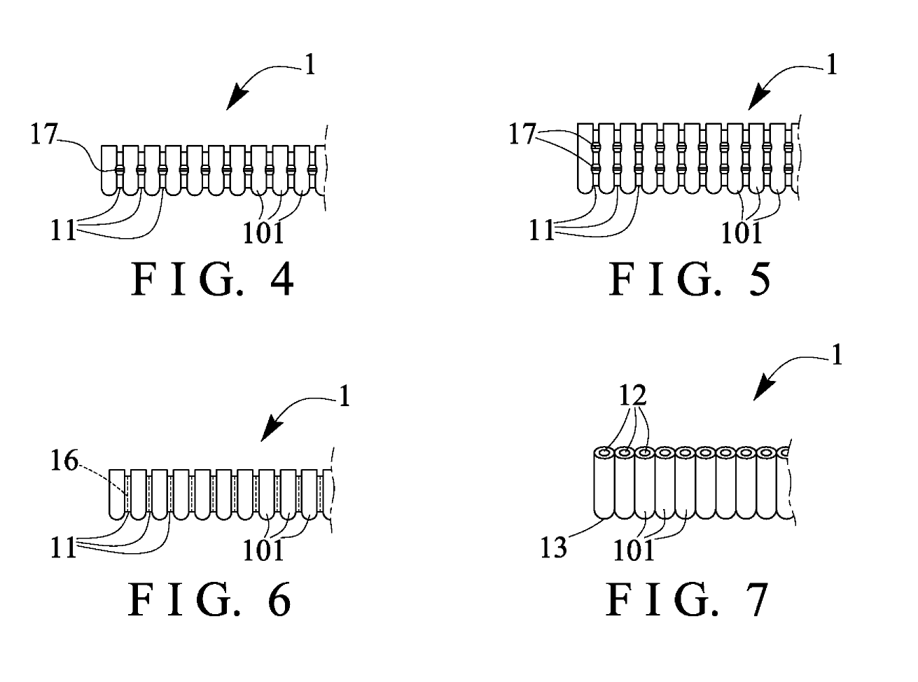

Alternatively, as shown in FIGS. 4 and 5, the coupling members 11 may be made of weak materials without the hinge lines formed or provided thereon, but may include one (FIG. 4) or more (FIG. 5) protrusion or projection or reinforcing members 17 formed or provided thereon for solidly and stably coupling the barrels 101 together and for preventing the coupling members 11 from being easily broken or cut. Or, as shown in FIG. 6, the coupling members 11 each may include only the hinge line 16 formed or provided therein, without the protrusion or projection or reinforcing members 17 formed or provided thereon. As shown in FIG. 7, the barrels 101 may also be directly connected or coupled together without the coupling members, and the barrels 101 may be disposed or arranged in parallel to each other and perpendicular to the coupling members 11 (FIGS. 4-6).

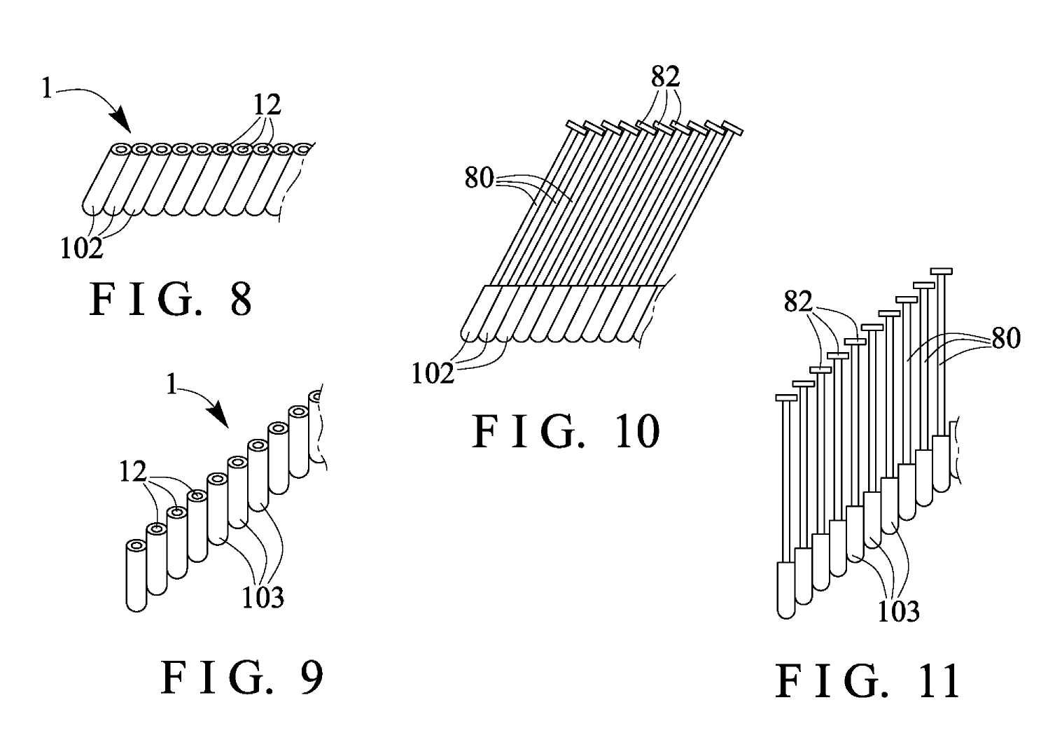

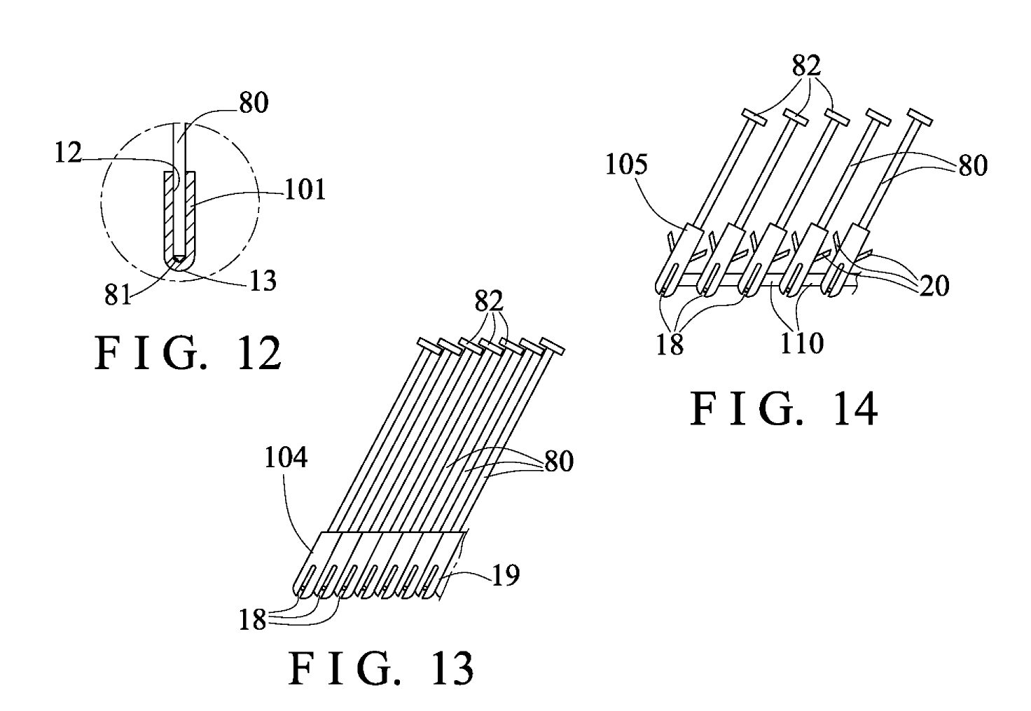

As shown in FIGS. 8 and 10, the barrels 102 may also be directly connected or coupled together without the coupling members, and the barrels 102 may be disposed or arranged in a tilted or inclined status relative each other, and disposed or arranged side by side. As shown in FIGS. 9 and 11, the barrels 103 may also be directly connected or coupled together without the coupling members, and the barrels 103 may be disposed or arranged one slightly above the other, or in a stagger way, and arranged for allowing the heads 82 of the fasteners 80 to be offset from each other. As shown in FIG. 12, the barrels 101 (FIGS. 4-7), 102 (FIGS. 8 and 10), 103 (FIGS. 9 and 11) may also include an enclosed or blocked end portion 13 for receiving or engaging with the tips 81 of the fasteners 80 and for preventing the tips of the fasteners 80 from being exposed and from hurting people.

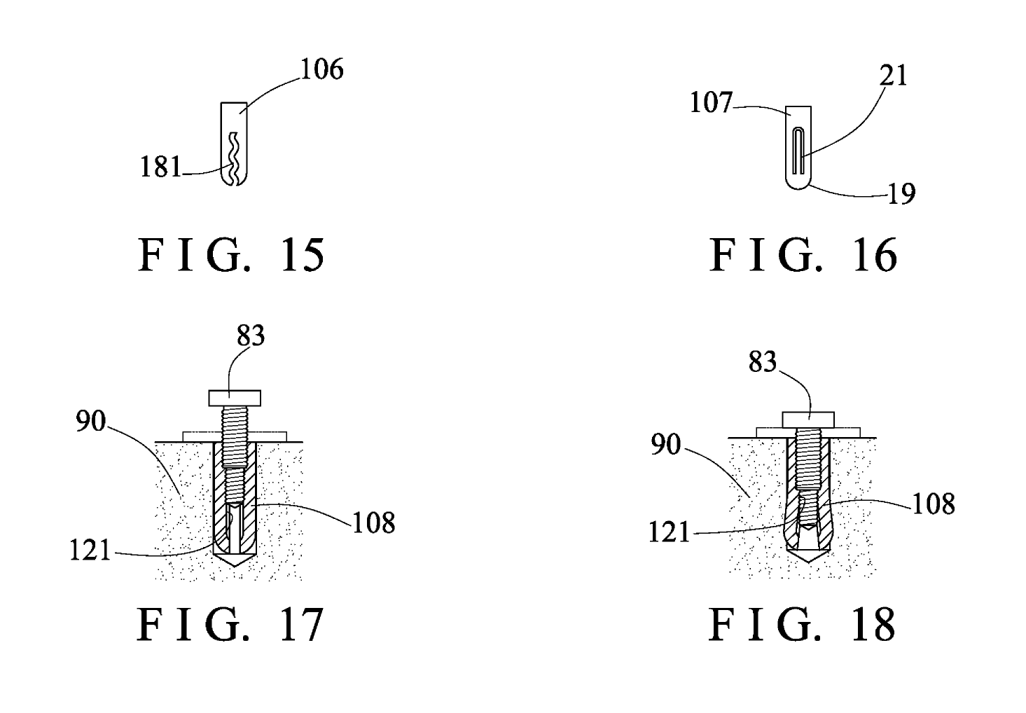

As shown in FIG. 13, the barrels 104 may also be directly connected or coupled together without the coupling members, and the barrels 104 each may further include a slit 18 formed in the lower portion 19 thereof for allowing the tips 81 of the fasteners 80 to be hammered or driven or moved out of the lower portion 19 of the barrel 104 and/or for allowing the lower portion 19 of the barrel 104 to be selectively expanded. As shown in FIG. 14, the barrels 105 may be connected or coupled together with coupling members 110, and each may further include one or more protrusion or projection or sticks 20 extended outwardly therefrom for anchoring or securing or retaining the barrel 105 in the work piece (not shown) after the barrel 105 and the fastener 80 are hammered or driven or moved into the work piece. As shown in FIG. 15, the slit 181 of the barrel 106 may be arranged or formed into the other shapes or contours or configurations.

As shown in FIG. 16, the barrel 107 may include a U shaped slot 21 formed therein, and disposed or arranged for allowing the tips of the fasteners to be hammered or driven or moved out of the lower portion of the barrel 107. As shown in FIGS. 17 and 18, the barrel 108 may include a stepped hole 121 formed therein for selectively receiving or engaging with the fastener 83 and for allowing the barrel 108 to be suitably expanded outwardly to engage with the work piece 90 and for anchoring or securing or retaining the barrel 108 in the work piece 90 after the barrel 108 and the fastener 83 are hammered or driven or moved into the work piece 90.

Accordingly, the fastener supporting strip in accordance with the present invention includes a number of sleeves or barrels coupled together for carrying and supporting and protecting staples, fasteners, nails, screws, bolts, or the like, and for preventing the tips of the staples, fasteners, nails, screws, bolts, or the like from being exposed and from hurting people.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A strip comprising:
a plurality of barrels coupled together and disposed side by side, said barrels each including a bore formed therein and having an open upper portion for receiving and engaging with a fastener, and said barrels each including an enclosed lower end portion for receiving a tip of the fastener and for preventing said tip of said fastener from being exposed.

2. The strip as claimed in claim 1 further comprising a plurality of coupling members, and each coupling member being coupled between every two adjacent barrels.

3. The strip as claimed in claim 2, wherein said coupling members each include a hinge line formed therein.

4. The strip as claimed in claim 2, wherein said coupling members each include a reinforcing member provided thereon for solidly coupling said barrels together.

5. The strip as claimed in claim 1, wherein said barrels are disposed in a tilted status relative to said coupling members.

6. The strip as claimed in claim 1, wherein said barrels each include a notch formed in said upper portion thereof and communicative with said bore of said barrel.

7. The strip as claimed in claim 1, wherein said barrels each include a slit formed in the lower end portion thereof for allowing the lower portion of the barrel to be selectively expanded.

8. The strip as claimed in claim 1, wherein said barrels each include at least one stick extended outwardly therefrom for anchoring purposes.
